(19) United States
(12) Patent Application Publication
(10) Pub. No.: US 2021/0034632 A1
(43) Pub. Date: Feb. 4, 2021

(54) SYSTEM AND METHOD FOR RELATIONSHIP MAPPING

(71) Applicant: James Garrison Meyer, Port Charlotte, FL (US)

(72) Inventor: James Garrison Meyer, Port Charlotte, FL (US)

(21) Appl. No.: 16/525,517

(22) Filed: Jul. 29, 2019

(51) Int. Cl. G06F 16/2457; G06F 16/28

(52) U.S. Cl. CPC G06F 16/24578; G06F 16/288

(57) ABSTRACT

A System and Method for Relationship Mapping provides individual consumer users in a first set of individuals with relationship information data relating to a second set of individuals having a business, group, entity or association that the individual consumer user wishes to engage. A control software manages communication with both the first and second set of individuals. A program control software returns results relevant to relationship information based upon latitude and longitude information.

### FIELD OF THE INVENTION

The present invention relates to the computer based mapping involved in searching systems that return locations of relevant search terms such as businesses and or professional firms. More particularly, the present invention relates to mapping using pre-existing data loaded in a mapping server combined with relevant data thereby enhancing the quality of data by improving the knowledge available to the user about existing business and or professional firms.

### BACKGROUND OF THE INVENTION

### Sorting Algorithms

Since the advent of early computing systems Sorting Algorithms has played a fundamental role in the processing of enormous quantities of data to achieve a useful result. Even more so now that the modern mobile phone, standalone computer, mainframe and supercomputer consume even more gigantic volumes of information, computer scientists and engineers pursue the most efficient and appropriate sorting algorithms in order to obtain the best results with as little computing power as possible. Many times, a sorting algorithm is either built into another main program or called therefrom. Typical examples of existing algorithms include the comparison, non-comparison, insertion sort, selection sort, merge sort, heap sort, quick sort, shell sort, bubble sort, comb sort, counting sort, bucket sort and radix sort. Many other types exist and these can tailored to meet the needs of the particular implementation so as to maximize computer processing power.

### Search Based Mapping Systems

Mobile phones have opened up the world to users whereby they can search for goods and services online almost without limit. The ubiquity of mobile phones has also facilitated the ability of a user to locate business nearby his or her present location. In order to do this there are various types of location tracking that help determine a user's location and correlate these against the search terms to return relevant results that closely match the search string. In order to accomplish this, the existing mobile architecture uses various mobile phone tracking techniques that process and identify the location of a phone whether it is stationary or moving.

Typically, a localization function occurs through multilateration of radio signals between several cell towers of a given network and the mobile phone; alternatively, a GPS (Global Positioning System) signal is used in the event that the phone is equipped therewith and the user has activated this service on his settings panel. Multilateration does not require an active call, rather, this process tracks using radio signals requiring the phone to emit at least the roaming signal in order to contact the adjacent tower. By comparing the relative signal strength from multiple antenna towers, a general location of a phone can be roughly determined. Other means make use of the antenna pattern, which supports angular determination and phase discrimination.

All of these location tracking services disclose the actual coordinates of a mobile phone which is a technology used by telecommunication companies thereby approximating a phone's location. A particular type of location tracking system is know as a Hybrid Positioning System that uses both network based and hand set based technologies to make a location determination. For example, Assisted GPS uses both GPS coordinate data and network information to accurately compute device position. Google Maps uses an alternative type of position tracking in that it uses GPS location directly from satellites and then has the information sent via the network to the person that is trying to locate the phone.

### Prior Art Systems

All of this data is used to provide listing of various businesses, professional firms, religious groups, government agencies, sports arenas and generally almost any type of organization that a user would wish to find. To gain access to this information, an individual using a mobile phone, desktop computer (similarly located using network positioning) or similar system enters a search string into the search box of Google®, Yahoo® or any other search engine. As a result, the search application software transmits the search query across the cellular network, internet or similar network to the search response server in order to receive a result therefrom. The search query is received at the search response server and the information is rapidly processed and a set of response data is prepared therefore using the existing database of items that are most relevant to the user query and location. The set of response data is transmitted back across the cellular, internet or other network back to the mobile phone, desktop computer or similar system where it is received and stored in temporary storage such as RAM or permanent storage such as a Hard Disk, eMMC Flash Memory, an SDCard and similar types of nonvolatile memory.

Wherever the data is stored, it is ultimately used by the processor in the computer system to present a list of pertinent information based on the search query mapped to nearby organizations nearby the user location. A map with highlighted pointers or dots, stars or similar indicators help pinpoint the several listing locations on the map. Thus, users can determine which group to contact based upon location and relevance to the original search query. Other possibilities include: a) engaging a phone button or number string presented next to a listing so that one can call them; or b) emailing a listing using an associated email; or c) even visiting the listing website.

However, a problem has arisen in that the quality of the listings has declined in that many listings can be manipulated; as a result, the confidence in the accuracy and results of a given provider or group has declined greatly damaging the trust in the mapping systems presently offered to users. Additionally, there is a no possible way that one can actually verify whether or not a given group will fulfill its obligations once a new relationship with the user has been established. Thus, there exists a need for a user to be able to know whether or not he or she can trust the group listing that he or she is using for business or personal reasons.

### SUMMARY OF THE INVENTION

The present invention overcomes the deficiencies of the known art and the problems that remain unsolved by providing:

A method for relationship mapping comprising the steps of:

receiving a user search at a dedicated relationship server query sent from a user computer to the dedicated relationship server;

a control software application stored on the dedicated server determining if there is a search result set for the user search query; and

storing the search result set in a query result space of the dedicated relationship server.

In another aspect, further comprising the step of:

setting a location flag to indicate that a search result was found.

In another aspect, further comprising the step of:

starting a relationship data search on the dedicated relationship server.

In another aspect, further comprising the step of:

determining if there is a relationship between a particular item of the search result set and data stored in an Existing Contact Database of the dedicated server.

In another aspect, further comprising the step of:

setting a relation flag to indicate that a relation exists between the particular item of the search result set and the Existing Contact Database of the dedicated server.

In another aspect, further comprising the step of:

checking whether or not a direct relationship exists between the searcher and the group in the Existing Contacts Database.

In another aspect, further comprising the step of:

setting a direct flag to indicate that a direct relationship exists between the searcher and the group in the Existing Contact Database of the dedicated server that has a True Flag set.

In another aspect, further comprising the step of:

determining if this is the last member of the search result set.

In another aspect, further comprising the step of:

in the event that this is the last member of the search result set, then
prioritizing the search result set to have the closest relationship located highest in a modified search result set.
   In another aspect, wherein the prioritizing the search result set to have the closest relationship located highest in a modified search result set further comprises the step of:

arranging the rest of the results to have the modified search result set prioritized according to relationship closeness wherein the search result set to have the closer relationship located higher in the modified search result set and the less close relationships located lower in the modified search results.

In another aspect, further comprising the step of:

a transmitting the modified search result set to a user computer.

In another aspect, wherein the relationship priority is indicated at an end user computer with an indicator from a group of indicators of: a color coding, an icon, a number.

A computer readable medium comprising instructions, which when executed by a processor cause performance of operations comprising:

receiving a user search at a dedicated relationship server query sent from a user computer to the dedicated relationship server;

a control software application stored on the dedicated server determining if there is a search result set for the user search query; and

storing the search result set in a query result space of the dedicated relationship server.

In another aspect, wherein the operations further comprise:

starting a relationship data search on the dedicated relationship server.

In another aspect, wherein the operations further comprise:

determining if there is a relationship between a particular item of the search result set and data stored in an Existing Contact Database of the dedicated server.

In another aspect, wherein the operations further comprise:

checking whether or not a direct relationship exists between the searcher and the group in the Existing Contacts Database.

In another aspect, wherein the operations further comprise:

prioritizing the search result set to have the closest relationship located highest in a modified search result set at the end of the search result set.

In another aspect, wherein the operations further comprise: the prioritizing the search result set to have the closest relationship located highest in a modified search result set further comprises the step of:

arranging the rest of the results to have the modified search result set prioritized according to relationship priority wherein the search result set to has high relationship priority located higher in the modified search result set and the less relationship priority located lower in the modified search results.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which a System and Method for Relationship Mapping is taught as described in the following Drawings:

FIG. 1 presents a broad overview of the System and Method for Relationship Mapping as taught in an embodiment disclosed herein.

FIG. 2 presents a diagram representing a server having various software and databases stored therein in an embodiment disclosed herein.

FIG. 3 presents an initialization process in flowchart form whereby the System and Method for Relationship Mapping is taught in an embodiment disclosed herein.

FIG. 4 presents the process by which the System and Method for Relationship Mapping is taught in an embodiment disclosed herein.

FIG. 5 presents an exemplary return of relationship mapped data returned to a mobile phone in an embodiment disclosed herein.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

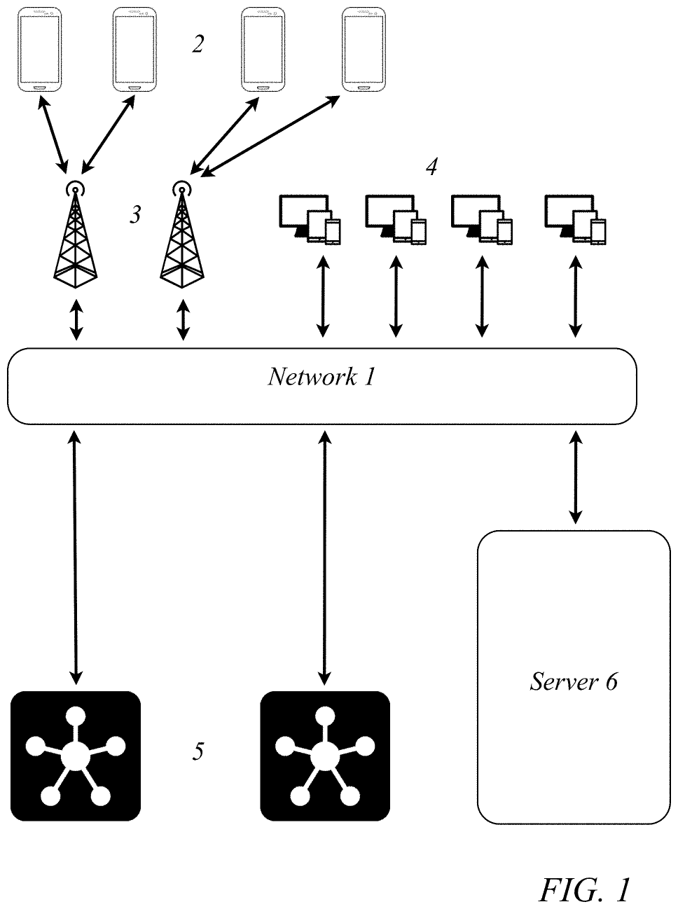

FIG. 1 presents a system level overview of the System and Method for Relationship Mapping as taught in an embodiment disclosed herein. FIG. 1A shows several advantageous features of the present invention, but as is to be described, the novelties discussed herein can be provided in several shapes, sizes, combinations of features and components and varying numbers and functions of the components. An example of a networked data processing system within which the concepts described herein can be practiced is shown including: a network 1, mobile phones 2 communicating through various mobile towers 3, various standalone computers 4 (or terminals connected to main network 1 via a mainframe or other network not shown), auxiliary networks 5 and a server system 6. The server system 6 itself comprises one or more servers housing various applications found in software operating in conjunction with hardware; the server system 6 can be co-located or dispersed to other sites as necessary to provide distributed functionality, control and communication in the event various system services or software are outsourced or to provide bandwidth load balancing across the network 1.

The server system 6 can be thought of as a single standalone computer operating as a server having its own application space and database storage for pertinent client information; in this implementation, it is receiving requests from clients and responding thereto according to the needs and capabilities thereof In another implementation, server system 6 is formed as a plurality of networked computers that together operate as a server system as for example in the ubiquitous cloud system token network, ring network and similar topologies. Of course, there are other possible implementations that would still be within the scope of the concepts disclosed herein.

In order to effectively communicate across the network 1 to the fullest extent possible, the communication links provided by the network can be hardwired or wireless connections. Exemplary wired connections include but are not limited to: cable, phone line and fiber optic linkages whilst exemplary wireless communications include but are not limited to radio frequency (RF) and infrared (IR) transmission. Of course, there are many other wired and wireless connection that are known in various technologies that are employable in the implementation of the various novelties discussed herein.

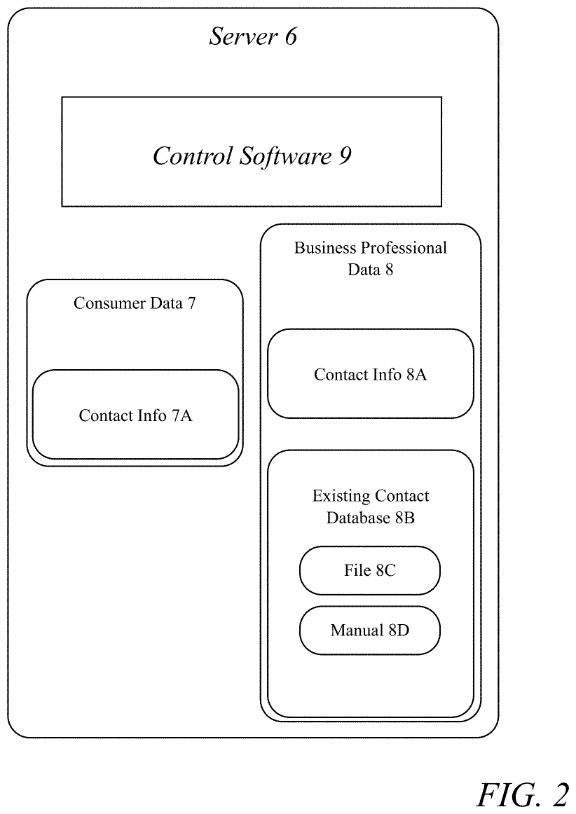

FIG. 2 presents a diagram representing a server having various software and databases stored therein in an embodiment disclosed herein. As stated previously, within the server(s) 6 are found various software applications and databases working with hardware to practice the novelties taught by the System and Method for Relationship Mapping. One software program not shown but understood, is the server operating system (OS) that communicates with the underlying hardware of the server, network interface and other glue logic so at to effect the basic operation and communication therewith. In order to accomplish the goals of the invention however, a control software 9 application resides within the nonvolatile memory space of the server 6 and communicates with the network 1 using a pre-programmed interface with the server OS.

Also, server 6 houses two separate databases that can alternatively be formed into an integral whole. These databases are a Consumer Database 7 and a Business Professional Database 8 housing various information related to the aforementioned. The information in these databases are populated during initial membership applications for both the Consumer Database 7 and Business Professional Database 8 and updated as necessary with files and or other directly inputted information into a menu driven Graphical User Interface (GUI). Thus, the Consumer Database 7 has Contact Information 7A stored therein such as Name, Address, Email Address, and member associations such as social media accounts and groups.

Similarly, the Business Professional Database 8 has Contact Information 8A stored therein such as Name, Address, Email Address, and member associations such as social media accounts and groups. However, the Business Professional Database 8 has a unique group of information stored therein beyond that of the Consumer Data 7 in that it accumulates an Existing Contact Database 8B from their various Business, Professional, Associations, and or Groups for individuals who sign up for the service who are willing to provide their unique listing of contacts for the sorting of relevant mapping information localized to the end consumer user.

This data is shown in the figure as being broken up into two groups inputed Files 8C where a business user has uploaded a File onto the Server 6 using an appropriate GUI prompt screen and Manually inputted data 8D where a business user has directly uploaded data through the use of a text input screen. Of course, these two are alternatively consolidated into one integral storage location and are shown separately to illustrate the mechanism by which they are loaded into the server. As touched upon above, when discussing a Business Professional User what is meant is any individual providing a useful service or product.

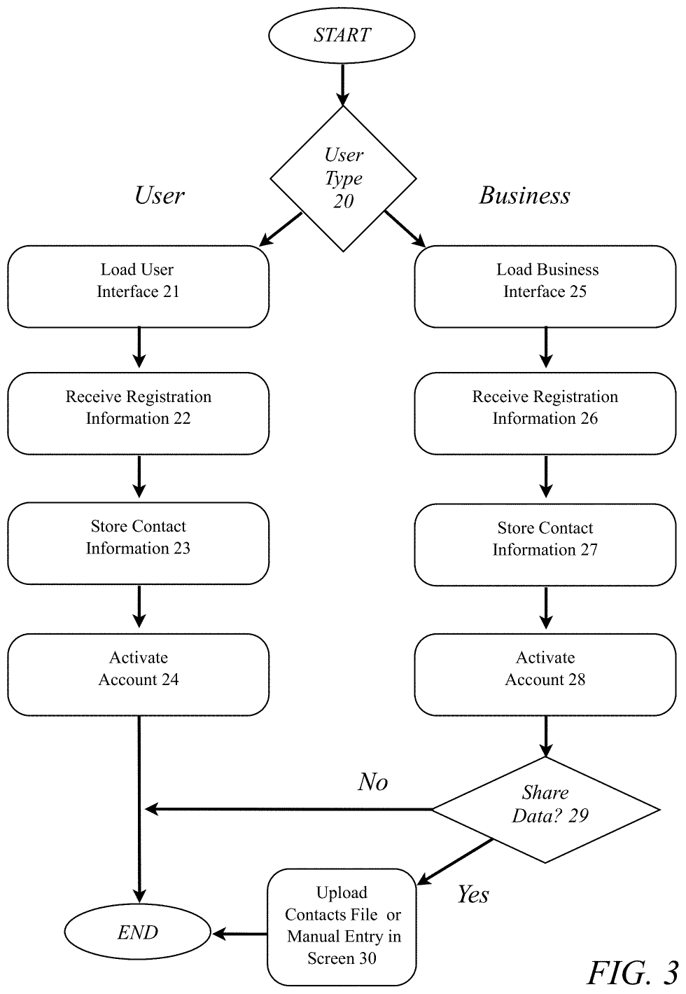

FIG. 3 presents an initialization process in flowchart form whereby the System and Method for Relationship Mapping is taught in an embodiment disclosed herein. The initialization process begins with the server sending an initial query 20 (via email popup or new window at initialization or signup) to a user as a button, link, checkbox or similar computer GUI components and receiving a reply indicative of the type of user. If the user reply is a Consumer User the process proceeds through the left branch in the diagram; if the user is as Business Professional, Association, Group or otherwise not an individual representing himself or herself, then the process proceeds through the right branch in the diagram.

With a consumer user, a User Interface is transmitted to the user mobile 2 or standalone computer 4 (or terminal) where it is loaded 21 into memory and presented to the user display so as to request various responses from the Consumer regarding Name, Address, Email, social media and or groups. This registration information is to be transmitted across network 1 and or through mobile towers 3. The information is first entered into an entry screen made up of text boxes, menu driven and or with other GUI components such as buttons and or checkboxes and so forth and then transmitted to the server 6. It is then received 22 by the server 6, processed by control software 9 and thereby stored 23 in Consumer Database 7 as Contact Information 7A. As a result of the reception and storage of this information the Account is activated 24 and the user initialization process ends.

With a Business Professional, association or group individual user, a Business Interface is transmitted to the Business mobile 2 or standalone computer 4 (or terminal) where it is loaded 25 into memory and presented to the user display so as to request various responses from the Business (group or association etc) individual regarding Name, Address, Email, social media and or groups. This registration information is to be transmitted across network 1, networks 5 and or through mobile towers 3. The information is first entered into an entry screen made up of text boxes, menu driven and or with other GUI components such as buttons and or checkboxes and so forth and transmitted to the server 6. It is then received 26 by the server 6, processed by control software 9 and thereby stored 27 in Business Database 8 as Contact Information 8A. As a result of the reception and storage of this information the Account is activated 28 and the user initialization process ends. For a Business Professional individual user (group or association etc), a small charge is required to originate the service in order to fund the system.

At this point the control software transmits a query to the Business user Mobile 2 or standalone computer 4 (or terminal) requesting 29 that relationship data be shared by the Business user. The request is formed as an entry screen made up of text boxes, menu driven and or with other GUI components such as buttons and or checkboxes and so forth. If the Business user chooses not to share data at this time, then the process ends.

However, if the Business user chooses to share data then another window screen opens presenting the Business user with the option to manually enter the information through text boxes, buttons, checkboxes and other GUI components or through uploading of a file using a simply browse button that when clicked accesses the local storage areas of the standalone computer, mobile, cloud, hard drive or other memory of the Business Professional suser for uploading of a file therefrom. This file contain the various fields necessary to define the relationship between users in a prearranged format such as NAME, ADDRESS, EMAIL, RELATIONSHIP TYPE, LAST CONTACT DATE and other useful relationship data. RELATIONSHIP TYPE would be information such as Client, Group Member, Mentor, Contract Employee and similar types of relationship data.

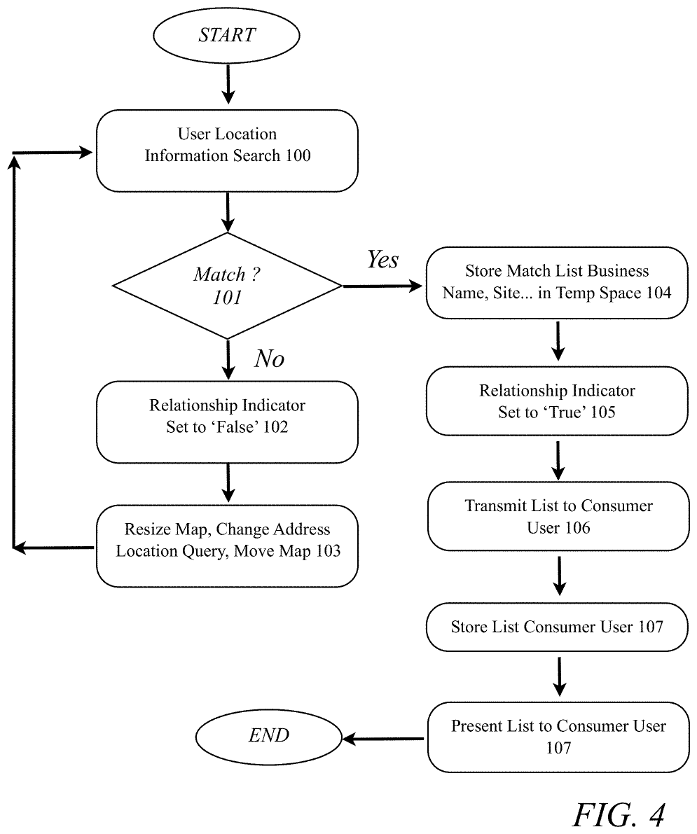

FIG. 4 presents a first portion of a process by which the System and Method for Relationship Mapping is taught in an embodiment disclosed herein. Once a consumer user on a mobile 2 or standalone computer 4 (or terminal) initiates 100 a location (latitude-longitude) information search in order to find a Business Professional individual (or entity such as trade, governmental, business, religious, group, or events and so forth) the search data is transmitted across mobile towers 3 and to network 1 or directly to network 1 (for standalone 4 or through auxiliary networks 5) and on to server 6 relaying it to control software 9 which processes this request.

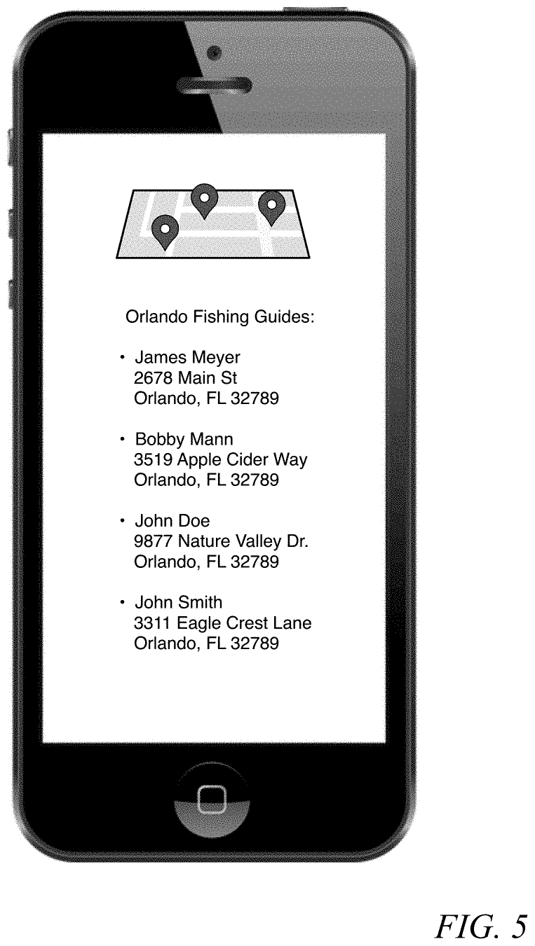

As an example, consider a user that wants to search for Orlando Fishing Guides as shown in FIG. 5. The consumer user transmits the request for Orlando Fishing Guides along his location data and a coverage metric within which he or she wishes to search. In this request, the application on the mobile 2 or standalone computer 4 (or terminal) activates an API having location data of the mobile 2 or standalone computer 4 (or terminal) using GPS, Tower Information, WIFI or similar types and transmits that location data to the server 6 for use by control software 9.

Results nearby the consumer user are determined according to the latitude and longitude of the consumer user within a coverage area or metric specified by the size of the window opened; or as directly inputted into a size variable menu or input box such as 1 mi, 2 mi, 5 mi, 10 mi, 20 miles radius and so forth appearing on the consumer user application window. Once entered into the input box or specified by the size of the window opened on the consumer search window, the coverage area or metric information is returned back the Control Software 9 for further processing as appropriate along with the location data described previously.

Thus, the Control Software 9 examines the consumer user location data (latitude-longitude) against information stored in the Business Professional Existing Contacts Database 8B using a coverage metric supplied by the consumer user. If there is No Match 101 then the Relationship Indicator is set to False 102 indicating that there is no search response matching the initial query in the local area. This is sent from the Control Software 9 to a fault handler internal subroutine (not shown) that informs the user of no information found at this location by requesting in a simple prompt to resize the map, change the address location, or move the current map window 103 so as to return positive results. After this prompt the user search box is returned to blank so as to restart the search process 100 again.

There is a match nearby the consumer user if there is a Business Professional (group, event, association) individual according to the latitude and longitude of the user within a coverage area specified by the size of the window opened; or as directly inputted into a size variable menu or input box such as 1 mi, 2 mi, 5 mi, 10 mi, 20 miles and so forth. When this happens, a List of these Business Professional Individual Names, Addresses, Sites, Phones, Photos and other useful information is stored 104 in a Temporary Space (not shown) on server 6 and a Relationship Indicator is Set to ‘True’ 105 regarding this specific transaction.

As a result, the Control Software 9 commands an interface routine to transmit 106 the stored list in the Temporary Space of the server 6 for the specific request back to the consumer user's 106 standalone, mobile, terminal or other data processing device. The consumer user computer system stores 107 the Relationship List in its local memory. Finally, the Relationship List is presented to a consumer user computer system display and the process ends.

FIG. 5 presents an exemplary return of relationship mapped data returned to a mobile phone in an embodiment disclosed herein. Here are shown individuals who have relationships such as James Meyer, Bobby Mann, John Doe and John Smith. The bulleted list is presented to a consumer user within a specified local area that has been searched. It is up to the user to make the final determination as to which result he or she will choose to click upon, research further and or engage in a business.

It should be understood that when described as a Business User or Business Professional User, what is meant is an individual person being a member of an association, entity, business, group or similar organization.

The above-described embodiments are merely exemplary illustrations of various implementations set forth for a clear understanding of the principles of the invention. Many variations, combinations, modifications or equivalents may be substituted for elements thereof without departing from the spirit and scope of the invention. Therefore, it is intended that the invention not be limited to the particular embodiments as disclosed, but that the invention will include all the embodiments falling within the scope of the appended claims.

What is claimed is:

1. A method for relationship mapping comprising the steps of:
receiving a user search at a dedicated relationship server query sent from a user computer to the dedicated relationship server;
a control software application stored on the dedicated server determining if there is a search result set for the user search query; and
storing the search result set in a query result space of the dedicated relationship server.

2. The method relationship mapping of claim 1, further comprising the step of:
setting a location flag to indicate that a search result was found.

3. The method relationship mapping of claim 1, further comprising the step of:
starting a relationship data search on the dedicated relationship server.

4. The method relationship mapping of claim 3, further comprising the step of:
determining if there is a relationship between a particular item of the search result set and data stored in an Existing Contact Database of the dedicated server.

5. The method relationship mapping of claim 4, further comprising the step of:
setting a relation flag to indicate that a relation exists between the particular item of the search result set and the Existing Contact Database of the dedicated server.

6. The method relationship mapping of claim 4, further comprising the step of:
checking whether or not a direct relationship exists between the searcher and the group in the Existing Contacts Database.

7. The method relationship mapping of claim 6, further comprising the step of:
setting a direct flag to indicate that a direct relationship exists between the searcher and the group in the Existing Contact Database of the dedicated server that has a True Flag set.

8. The method relationship mapping of claim 6, further comprising the step of:
determining if this is the last member of the search result set.

9. The method relationship mapping of claim 8, further comprising the step of:
in the event that this is the last member of the search result set, then
prioritizing the search result set to have the closest relationship located highest in a modified search result set.

10. The method relationship mapping of claim 9, wherein the prioritizing the search result set to have the closest relationship located highest in a modified search result set further comprises the step of:
arranging the rest of the results to have the modified search result set prioritized according to relationship priority wherein the search result set to have the relationship priority located higher in the modified search result set and the less relationship priority located lower in the modified search results.

11. The method relationship mapping of claim 10, further comprising the step of:
transmitting the modified search result set to a user computer.

12. The method relationship mapping of claim 10, further comprising the step of:
arranging non-relationship members of the modified search result set to the bottom of the set alphabetically therein.

13. The method relationship mapping of claim 11, wherein the relationship priority is indicated at an end user computer with an indicator from a group of indicators of: a color coding, an icon, a number.

14. A computer readable medium comprising instructions, which when executed by a processor cause performance of operations comprising:
receiving a user search at a dedicated relationship server query sent from a user computer to the dedicated relationship server;
a control software application stored on the dedicated server determining if there is a search result set for the user search query; and
storing the search result set in a query result space of the dedicated relationship server.

15. The computer readable medium of claim 14, wherein the operations further comprise:
starting a relationship data search on the dedicated relationship server.

16. The computer readable medium of claim 15, wherein the operations further comprise:
determining if there is a relationship between a particular item of the search result set and data stored in an Existing Contact Database of the dedicated server.

17. The computer readable medium of claim 16, wherein the operations further comprise:
checking whether or not a direct relationship exists between the searcher and the group in the Existing Contacts Database.

18. The computer readable medium of claim 17, wherein the operations further comprise:
prioritizing the search result set to have the closest relationship located highest in a modified search result set at the end of the search result set.

19. The computer readable medium of claim 18, wherein the operations further comprise: the prioritizing the search result set to have the closest relationship located highest in a modified search result set further comprises the step of:
arranging the rest of the results to have the modified search result set prioritized according to relationship priority wherein the search result set to has high relationship priority located higher in the modified search result set and the less relationship priority located lower in the modified search results.
